(19) United States
(12) Patent Application Publication
(10) Pub. No.: US 2009/0222615 A1
(43) Pub. Date: Sep. 3, 2009

(54) Information Processing Apparatus and Nonvolatile Semiconductor Memory Drive

(75) Inventor: Takehiko Kurashige, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/390,274

(22) Filed: Feb. 20, 2009

Related U.S. Application Data
(63) Continuation of application No. PCT/JP2008/070718, filed on Nov. 7, 2008.

(30) Foreign Application Priority Data
Feb. 29, 2008 (JP) 2008-050806

(51) Int. Cl. G06F 12/02; G06F 12/00

(52) U.S. Cl. 711/103; 711/170; 711/E12.001; 711/E12.002; 711/E12.008

(57) ABSTRACT

According to one embodiment, a nonvolatile semiconductor memory includes a first memory area which is formed of a fixed area to which a predetermined physical address range is allocated, and which stores management information including an address management table indicative of a correspondency between logical block address and physical addresses of the nonvolatile semiconductor memory, and a second memory area to which a first logical address range is allocated and which stores log data indicative of an operation condition of the nonvolatile semiconductor memory drive. A control module accesses the first memory area by using the physical address belonging to the predetermined physical address range in a case of reading or writing the management information, and accesses the second memory area by using the physical address corresponding to the logical block address belonging to the first logical address range, which is obtained by referring to the address management table.

### CROSS REFERENCE TO RELATED APPLICATIONS

This is a Continuation Application of PCT Application No. PCT/JP2008/070718, filed Nov. 7, 2008, which was published under PCT Article 21(2) in English.

This application is based upon and claims the benefit of priority from Japanese Patent Application No. 2008-050806, filed Feb. 29, 2008, the entire contents of which are incorporated herein by reference.

### BACKGROUND

1. Field

One embodiment of the invention relates to an information processing apparatus and a nonvolatile semiconductor memory drive.

2. Description of the Related Art

As a system for managing a memory, there is known a memory system which is disclosed, for example, in Jpn. Pat. Appln. KOKOKU Publication No. 8-27758.

This memory system includes a control unit which manages a plurality of memory cards each having a plurality of memory units. The control unit stores, in its memory part, memory capacity information of each memory unit. In a case where a failure has occurred in a certain memory unit, the control unit renders the failed unit ineffective and re-allocates addresses to the other memory units. Thereby, even if a certain memory unit has failed, the operation can be resumed.

In this memory system, however, no particular consideration is given to how to manage various management information other than user data. As regards a nonvolatile semiconductor memory drive which is mounted and used as an external storage device of an information processing apparatus, it is necessary to manage various management information and log data within the nonvolatile semiconductor memory drive, as well as executing an operation for reading/writing user data. It is thus required to realize a novel function for efficiently accessing management information and log data.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view showing the external appearance of an information processing apparatus according to an embodiment of the present invention;

FIG. 2 is a block diagram which schematically shows the structure of the information processing apparatus according to the embodiment;

FIG. 3 is a block diagram which schematically shows the structure of an SSD that is used in the information processing apparatus according to the embodiment;

FIG. 4 schematically shows examples of the memory capacities and memory areas of the SSD shown in FIG. 3; and

FIG. 5 is a flow chart illustrating an example of the procedure which is executed at the time of a manufacturing process of the SSD shown in FIG. 3.

### DETAILED DESCRIPTION

Various embodiments according to the invention will be described hereinafter with reference to the accompanying drawings. In general, according to one embodiment of the invention, there is provided an information processing apparatus comprising: an information processing apparatus main body; and a nonvolatile semiconductor memory drive which is accommodated in the information processing apparatus main body, the nonvolatile semiconductor memory drive including a nonvolatile semiconductor memory and a control module, the nonvolatile semiconductor memory including a first memory area which is formed of a fixed area to which a predetermined physical address range is allocated, and which stores management information including an address management table indicative of a correspondency between logical block address and physical addresses of the nonvolatile semiconductor memory, and a second memory area to which a first logical address range is allocated and which stores log data indicative of an operation condition of the nonvolatile semiconductor memory drive, and the control module accessing the first memory area by using the physical address belonging to the predetermined physical address range in a case of reading or writing the management information, and accessing the second memory area by using the physical address corresponding to the logical block address belonging to the first logical address range, which is obtained by referring to the address management table, in a case of reading or writing the log data.

According to this information processing apparatus, it is possible to efficiently execute access to management information and log data.

<Structure of Information Processing Apparatus>

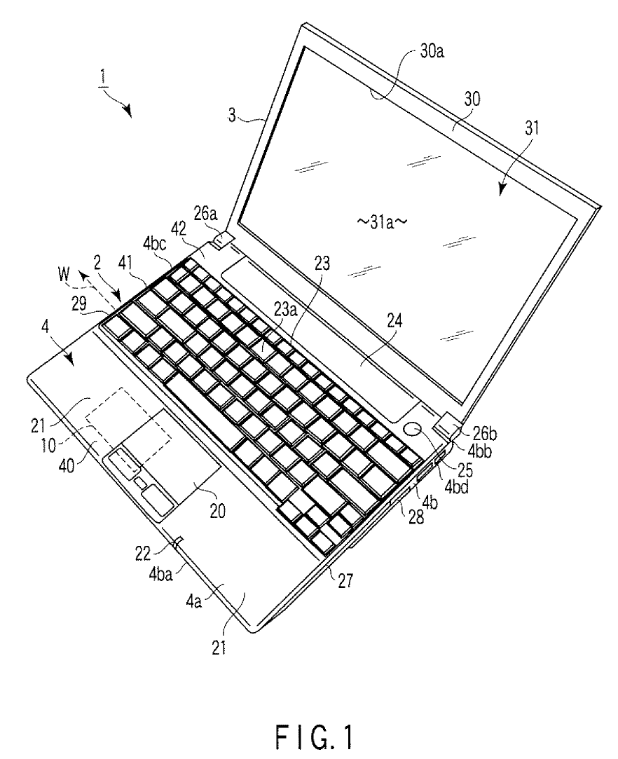

FIG. 1 is a perspective view showing the external appearance of an information processing apparatus according to an embodiment of the present invention.

This information processing apparatus 1 is composed of an information processing apparatus main body 2 and a display unit 3 which is attached to the information processing apparatus main body 2.

The main body 2 has a box-shaped casing 4. The casing 4 includes an upper wall 4a, a peripheral wall 4b and a lower wall (not shown). The upper wall 4a of the casing 4 includes a front part 40, a central part 41 and a back part 42 in the named order from the side close to a user who operates the information processing apparatus 1. The lower wall is opposed to an installation surface on which the information processing apparatus 1 is disposed. The peripheral wall 4b includes a front wall 4ba, a rear wall 4bb and left and right side walls 4bc and 4bd.

The front part 40 includes a touch pad 20 which is a pointing device, a palm rest 21, and an LED 22 which is turned on in association with the operation of respective parts of the information processing apparatus 1.

The central part 41 includes a keyboard mounting part 23 to which a keyboard 23a, which can input character information, etc., is attached.

The back part 42 includes a battery pack 24 which is detachably attached. A power switch 25 for powering on the information processing apparatus 1 is provided on the right side of the battery pack 24. A pair of hinge portions 26a and 26b, which rotatably support the display unit 3, are provided on the left and right sides of the battery pack 24.

An exhaust port 29 for exhausting the wind W to the outside from the inside of the casing 4, is provided on the left side wail 4bc of the casing 4. In addition, an ODD (Optical Disc Drive) 27, which can read and write data on an optical storage medium such as a DUD, and a card slot 28, in/from which various cards can be inserted/taken out, are disposed on the right side wall 4bd.

The casing 4 is formed of a casing cover including a part of the peripheral wall 4b and the upper wall 4a, and a casing base including a part of the peripheral wall 4b and the lower wall. The casing cover is detachably coupled to the casing base, and an accommodation space is formed between the casing cover and the casing base. This accommodation space accommodates, for instance, an SSD (Solid State Drive) 10 functioning as a nonvolatile semiconductor memory drive. The details of the SSD 10 will be described later.

The display unit 3 includes a display housing 30 having an opening portion 30a, and a display device 31 which is composed of, e.g. an LCD which can display an image on a display screen 31a. The display device 31 is accommodated in the display housing 30, and the display screen 31a is exposed to the outside of the display housing 30 through the opening portion 30a.

The casing 4 accommodates a main circuit board, an expansion module, a fan, etc., which are not shown, in addition to the above-described SSD 10, battery pack 24, ODD 27 and card slot 28.

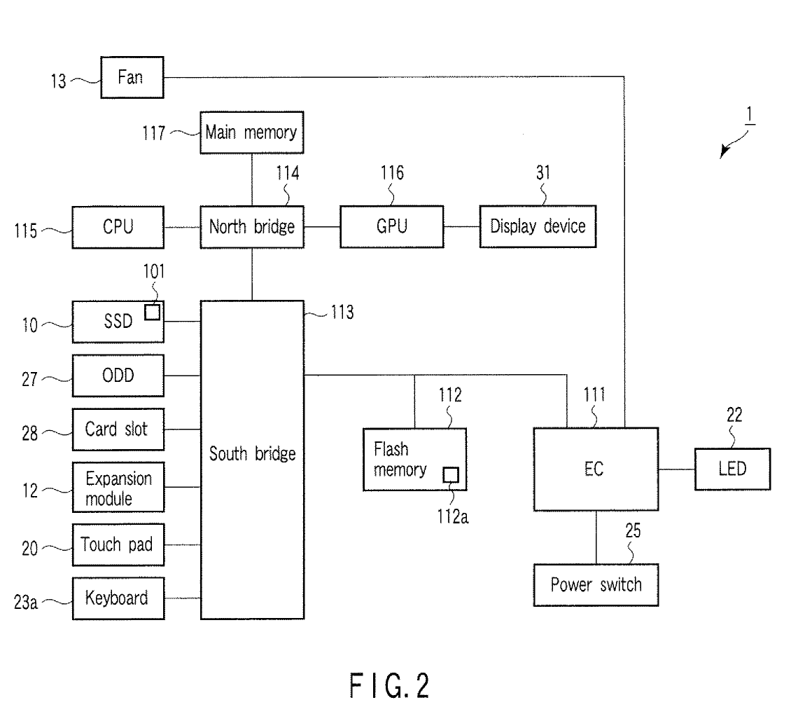

FIG. 2 is a block diagram which schematically shows the structure of the information processing apparatus according to the embodiment of the present invention.

This information processing apparatus 1, as shown in FIG. 2, includes an EC (Embedded Controller) 111, a flash memory 112 which stores a BIOS (Basic Input Output System) 112a, a south bridge 113, a north bridge 114, a CPU (Central Processing Unit) 115, a CPU (Graphic Processing Unit) 116 and a main memory 117, in addition to the above-described SSD 10, expansion module 12, fan 13, touch pad 20, LED 22, keyboard 23a, power switch 25, ODD 27, card slot 28 and display device 31.

The EC (Embedded Controller) 111 is a built-in system which controls the respective parts. The north bridge 114 is an LSI which controls connection between the CPU 115, GPU 116, main memory 117 and various buses. The CPU 15 is a processor which performs arithmetic processing of various signals, and executes an operating system and various application programs, which are loaded from the SSD 10 into the main memory 117. The GPU 116 is a display controller which executes display control by performing arithmetic processing of a video signal.

The expansion module 12 includes an expansion circuit board, a card socket which is provided on the expansion circuit board, and an expansion module board which is inserted in the card socket. The card socket supports, e.g. the Mini-PCI standard. Examples of the expansion module board include a 3G (3rd Generation) module, a TV tuner, a GPS module, and a Wimax (trademark) module.

The fan 13 is a cooling unit which cools the inside of the casing 4 on the basis of air feeding, and exhausts the air in the casing 4 to the outside as the wind W via the exhaust port 29.

The EC 111, flash memory 112, south bridge 113, north bridge 114, CPU 115, CPU 116 and main memory 117 are electronic components which are mounted on the main circuit board.

The SSD 10 is an external storage device which stores data and programs, and the storage content thereof is not lost even if no power is supplied. The SSD 10 is a drive which, unlike a hard disk drive, does not have a driving mechanism of a magnetic disk, a head, etc., but the SSD 10 can store programs, such as the OS (Operating System), and data which is created by the user or created on the basis of software, in memory areas of a NAND memory, which is a nonvolatile semiconductor memory, for a long time in a readable/writable manner, and can operate as a boot drive of the information processing apparatus 1.

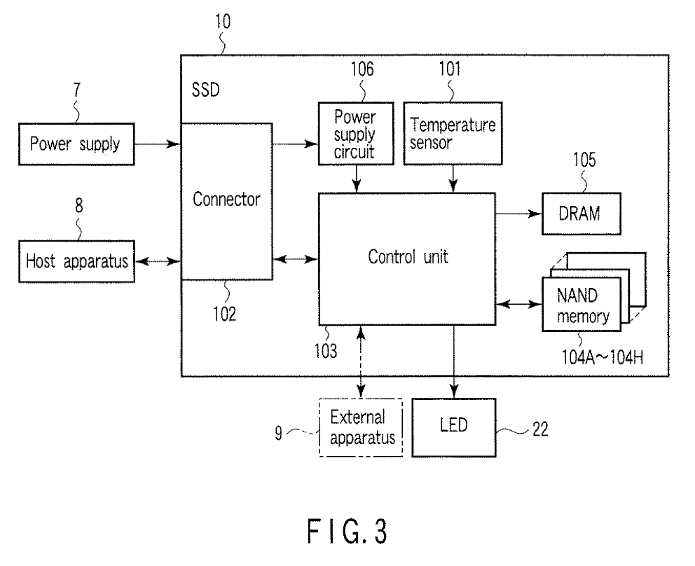

FIG. 3 is a block diagram which schematically shows the structure of the SSD that is used in the present embodiment.

A control unit 103, which functions as a memory controller, is connected to a temperature sensor 101, a connector 102, eight NAND memories 104A to 104H, a DRAM 105 and a power supply circuit 106. In addition, the control unit 103 is connected to the host apparatus 8 via the connector 102, and is connected, where necessary, to an external apparatus 9.

A power supply 7 is the battery pack 24 or an AC adapter (not shown). For example, a power of DC 3.3V is supplied to the power supply circuit 106 via the connector 102. In addition, the power supply 7 supplies power to the entirety of the information processing apparatus 1.

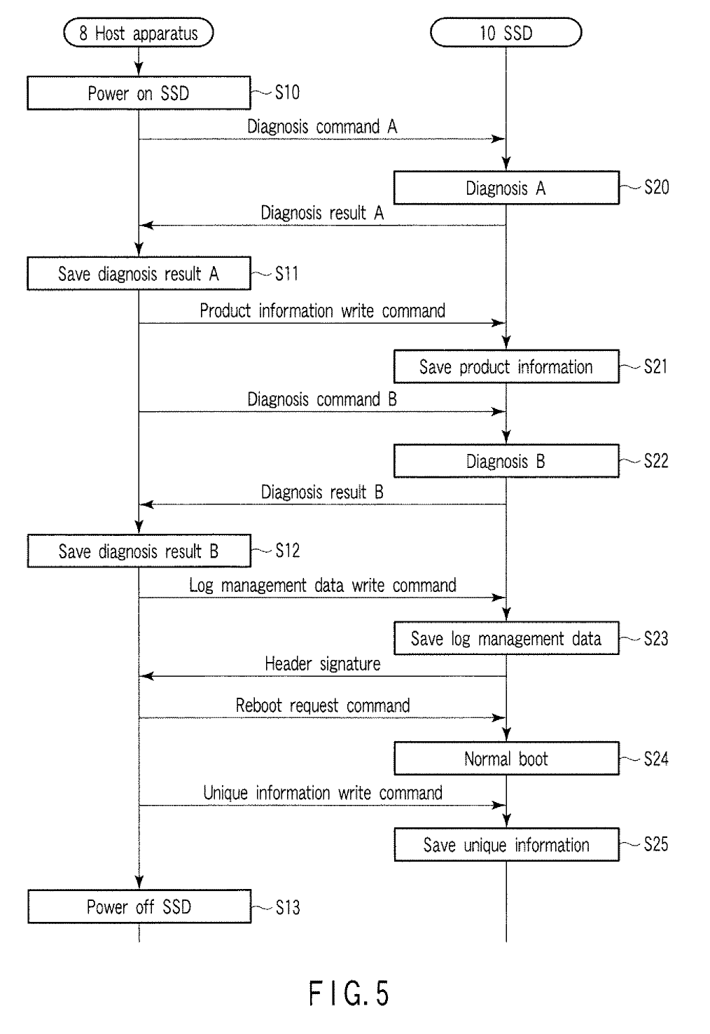

In the present embodiment, the host apparatus 8 is the information processing apparatus 1 (the information processing apparatus main body 2 of the information processing apparatus 1), and the south bridge 113, which is mounted on the main circuit board, is connected to the control unit 103. Data transmission/reception is executed between the south bridge 113 and control unit 103, for example, on the basis of the serial ATA standard. In addition, in FIG. 5 which will be described later, the host apparatus 8 is an apparatus which is connected at the time of manufacture of the SSD 10.

The external apparatus 9 is an information processing apparatus which is different from the information processing apparatus 1. The external apparatus 9 is connected to the control unit 103 of the SSD 10 which is removed from the information processing apparatus 1, for example, on the basis of the RS-232C standard, and the external apparatus 9 has a function of reading out data which is stored in the NAND memories 104A to 104H.

The board, on which the SSD 10 is mounted, has the same outside size as an HDD (Hard Disk Drive) of, e.g. 1.8-inch type or 2.5-inch type. In the present embodiment, this board has the same outside size as the 1.8-inch type HDD.

On the board, the temperature sensor 101 is provided between the control unit 103 and the NAND memories 104A to 104H, both of which are heat sources. In the present embodiment, the temperature sensor 101 is provided approximately on a central part of the board in such a manner that the temperature sensor 101 is surrounded by the control unit 103 and the NAND memories 104A to 104H, and the temperature sensor 101 measures the temperature at that position. The measured temperature, which is measured by the temperature sensor 101, is sent to the control unit 103 as temperature information. In this embodiment, as the temperature sensor 101, use is made of a semiconductor temperature sensor which makes use of such characteristics that the voltage of a PN junction part of a semiconductor varies depending on temperature. However, use may be made of temperature sensors using other methods, such as a thermistor.

The temperature detected by the temperature sensor 101 provided at the above-described position is, e.g. 50° C. to 60° C. in the case where the SSD 10 is in operation, and this temperature is higher than the temperature of the other region of the board by about 10° C.

The control unit 103 is a control module configured to control an operation on the NAND memories 104A to 104H. Specifically, in accordance with a request (read command, write command, etc.) from the host apparatus 8, the control unit 103 controls data read/write on the NAND memories 104A to 104H. The data transfer speed is, for example, 100 MB/Sec at a data read and 40 MB/Sec at a data write.

The control unit 103 acquires temperature information from the temperature sensor 101 at fixed cycles, and lowers the response to the host apparatus 8 when the measured temperature indicated by the temperature information exceeds a preset specified value. The operation of lowering the response is an operation of restricting a part of the processing performance of the SSD 10. Examples of the operation of lowering the response include an operation of decreasing the transfer speed at the time of transferring read data from the NAND memory, 104A to 104H, to the host apparatus 8, and an operation of decreasing the transfer speed between the control unit 103 and the NAND memory, 104A to 104H.

When the measured temperature exceeds the specified value, the control unit 103 outputs an alarm signal to the host apparatus 8 as information to that effect. The control unit 103 may output, instead of the alarm signal, temperature information itself to the host apparatus 8.

In addition, the control unit 103 writes the acquired temperature information, together with the data/time of acquisition, at a predetermined address of the NAND memory, 104A to 104H.

Each of the NAND memories 104A to 104H is a nonvolatile semiconductor memory having a memory capacity of, e.g. 16 GB. Each of the NAND memories 104A to 104H is composed of, e.g. an MLC (Multi-Level Cell)-NAND memory (multilevel NAND memory) in which 2 bits can be recorded in one memory cell. The MLC-NAND memory has such features that the allowable number of rewrites is smaller than an SLC (Single-Level Cell)-NAND memory, but the memory capacity can be increased more easily than the SLC (Single-Level Cell)-NAND memory. In addition, the NAND memories 104A to 104H have such characteristics that the time period, in which data can be retained, varies depending on the temperature of the environment in which they are disposed.

The NAND memory 104A to 104H store data which is written by the control of the control unit 103, and temperature information and the date/time of acquisition of temperature information as the history of temperatures.

The DRAM 105 is a buffer which temporarily stores data when data read/write is executed on the NAND memory, 104A to 104H, by the control of the control unit 103.

The connector 102 has a shape based on, e.g. the serial ATA standard. The control unit 103 and power supply circuit 106 may be connected to the host apparatus 8 and power supply 7 via different connectors.

The power supply circuit 106 converts DC 3.3V, which is supplied from the power supply 7, to, e.g. DC 1.8V and 1.2V, and supplies these three kinds of voltages to the respective parts in accordance with the driving voltages of the respective parts of the SSD 10.

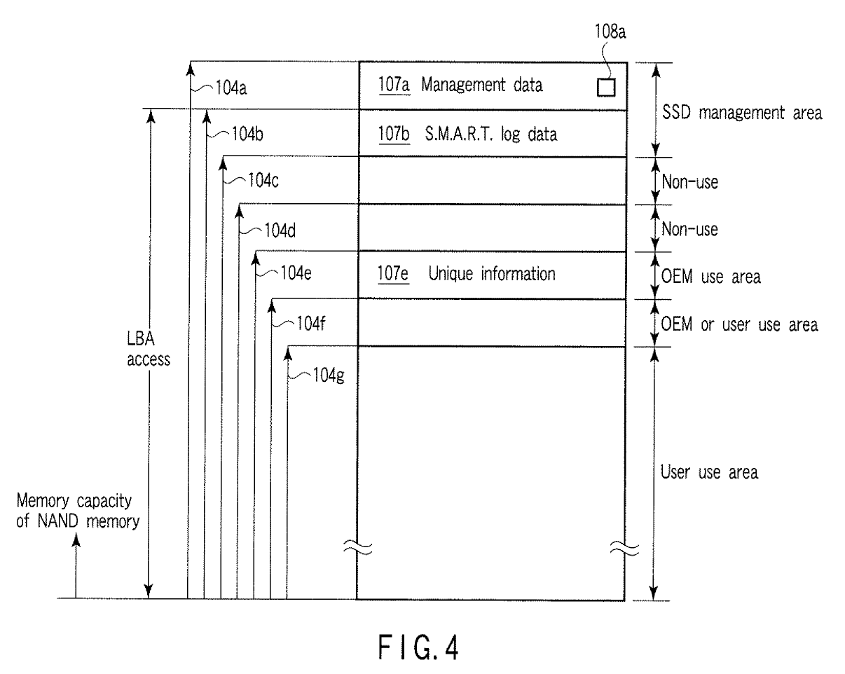

FIG. 4 schematically shows examples of the memory capacities and memory areas of the SSD 10 which is used in the present embodiment.

The control unit 103 of the SSD 10 manages seven kinds of memory capacities 104a to 104g, which are shown in FIG. 4.

The memory capacity 104a (first memory capacity information) is NAND Capacity, and is a maximum memory capacity using the memory areas of all NAND memories 104 to 104H. Specifically, the memory capacity 104a is the sum of the physical memory capacities of the NAND memories 104A to 104H. For example, if the memory capacity of each of the NAND memories 104A to 104H is 16 GB, the memory capacity 104a is 128 GB. The memory capacity 104a, i.e. the NAND Capacity, is given by, e.g. NAND structure information of a manufacture information write command of a DART (Universal Asynchronous Receiver Transmitter).

The memory capacity 104b (second memory capacity Information) is Max Logical Capacity, and is a maximum memory capacity that is accessible by a logical block address (LBA).

The memory capacity 104c (third memory capacity information) is a S.M.A.R.T. log area start LBA, and 1s provided in order to divide the memory capacity 104b and the memory capacity 104d which will be described below. The S.M.A.R.T. log area start LBA indicates a first LBA of the memory area which stores log data.

The memory capacity 104d (fourth memory capacity information) is Vender Native Capacity, and is a maximum memory capacity which is given as a user use area. The memory capacity 104d is given by, e.g. initial Identify Device data of an ATA specific command. In addition, the memory capacity 104d is determined by the manufacturer (Vender) at the time of design of the SSD 10 on the basis of the IDEMA (The International Disk Drive Equipment and Materials Association) standard, and is expressed by the following equation:

LBA=97,696,368+(1,953,504×((Capacity in GB)−50)).

The memory capacity 104e is OEM Native Capacity, and is a memory capacity which is determined at the time of manufacture by a request of an OEM (Original Equipment Manufacturer). The memory capacity 104e is given by, e.g. unique information write of an ATA specific command. In addition, the memory capacity 104e is a value which is returned by a Device Configuration Identify command when Device Configuration Overlay Feature Set is supported.

The memory capacity 104f is Native Capacity, and its initial value is equal to the memory capacity 104e. This value can be varied by a Device Configuration Set command when Feature Set is supported. In addition, the memory capacity 104f is a value which is returned by a Read Native Max Address (EXT) command.

The memory capacity 104g is Current Capacity and is a memory capacity during use by the user, and the initial value is equal to the memory capacity 104f. This value can be varied by a SET Max Address command. This value is returned by Word 61:60, and Word 103:100 of an Identify Device command.

The memory areas of the SSD 10 are present between the memory capacities 104a to 104g.

The memory area (first memory area) between the memory capacities 104a and 104b stores management information for operating the SSD 10. The control unit 103 controls an access for the NAND memories 104A to 104H based on the management information. The management information includes an address conversion table (logical/physical table) 108a. Specifically, the memory area between the memory capacities 104a and 104b stores management data 107a for operating the SSD 10, and the address conversion table (logical/physical table) 108a. The address conversion table (logical/physical table) 108a is an address management table for converting each LBA to a physical address corresponding to a sector which is a memory unit of the NAND memories 104A to 104H. The address conversion table (logical/physical table) 108a indicates the correspondency between the logical block addresses and the physical addresses (flash addresses) of the NAND memories 104A to 104H. Each of the management data 107a and logical/physical table 108a is data which is recorded in fixed areas in the NAND memories 104A to 104H. The LBA is not allocated to each of the management data 107a and logical/physical table 108a. Thus, each of the management data 107a and logical/physical table 108a cannot be accessed, with the LBA being used as a key. The control unit 103 has a fixed access path for accessing each of the management data 107a and logical/physical table 108a, and executes access to each of the management data 107a and logical/physical table 108a via the fixed access path.

Specifically, the memory area (first memory area) between the memory capacities 104a and 104b is formed of a fixed area of the memory area (NAND memory area) of the NAND memories 104A to 104H, to which fixed area a predetermined physical address range is allocated. The management information (management data 107a and logical/physical table 108a) is always present at the same location (the first memory area) in the NAND memory area. The firmware of the control unit 103 holds a physical address range corresponding to the first memory area, and accesses the first memory area by a fixed access path using each physical address in this physical address range. In other words, in the case where the management information (management data 107a and logical/physical table 108a) is to be read or written, the control unit 103 accesses the first memory area by using the physical address which belongs to the physical address range corresponding to the first memory area, without referring to the logical/physical table 108a.

The memory area (second memory area) between the memory capacities 104b and 104c stores S.M.A.R.T. (Self-Monitoring Analysis and Reporting Technology) log data 107b. The S.M.A.R.T. log data 107b is log data indicative of the operation condition of the SSD 10. This log data (also referred to as “memory check history information”) includes S.M.A.R.T.-related data, which is diagnosis result data which is obtained by a self-diagnosis function of the control unit 103, and various statistical Information such as temperature information. A predetermined logical address range (first logical address range) is allocated to the second memory area. Specifically, the LBAs belonging to the first logical address range are allocated to the second memory area. When the S.M.A.R.T. log data 107b is to be read or written, the control unit 103 accesses the second memory area by using a physical address corresponding to each logical block address belonging to the first logical address range, which is obtained by referring to the logical/physical table 108a.

For example, LBAs are allocated to a plurality of log items which constitute the S.M.A.R.T. log data 107b. The control unit 103 refers to the logical/physical table 108a and acquires, from the logical/physical table 108a, the physical address corresponding to the LBA which is allocated to the log item that is the object of read/write access. The control unit 103 accesses the NAND memory area by using the acquired physical address, and executes read or write of log information at the memory location in the NAND memory area, which is designated by the acquired physical address.

Each LBA that is allocated to the S.M.A.R.T. log data 107b is locally used in order for the firmware, which is executed in the control unit 103, to access the S.M.A.R.T. log data 107b. The firmware, which is executed in the control unit 103, can access the S.M.A.R.T. log data 107b by using the LBA as a key, but the host apparatus 8 cannot access the S.M.A.R.T. log data 107b by an ordinary read or write command.

As has been described above, since the LBA is allocated to the second memory area, the physical memory location in the NAND memory area, at which the S.M.A.R.T. log data 107b is stored, is not fixed, but can be changed to an arbitrary memory location in the NAND memory area. In the SSD 10, the read/write of the S.M.A.R.T. log data 107b can be controlled by the same control procedure as that of user data.

A non-use memory area having a memory capacity of, e.g. 2 MB is set in the memory area between the memory capacities 104c and 104d. The reason for this is that the minimum memory unit of the LBA is 8 sectors, which is a memory unit corresponding to 4 KB (a large memory unit is 1 MB), whereas the actual minimum recording unit of data is 1 sector as a matter of course, and thus the S.M.A.R.T. log data 107b and the data recorded in the memory area equal to or lower than the memory capacity 104d are independently handled by providing an empty memory area with a memory capacity of 1 MB or more.

The memory area between the memory capacities 104d and 104e is a non-use area, and the memory capacity 104d and 104e have the same value except for a particular case.

The memory area between the memory capacities 104e and 104f is a memory area which is used by the OEM. As described above, the unique information, which is determined by the request of the OEM, is written in this memory area.

The memory area between the memory capacities 104f and 104g is a memory area which is used by the OEM or the user. Data write is executed in this memory area by the setting of the OEM or user.

The memory area of the memory capacity 104g is a memory area which is used by the user, and information write is executed in this memory area by the setting of the user.

The memory capacities 104a to 104g satisfy a relationship which is expressed by the following formula:

memory capacity 104a>memory capacity 104b>memory capacity 104c>memory capacity 104d≧memory capacity 104e≧memory capacity 104f≧memory capacity 104g.

At the time of shipment from the manufacturer (Vender), the memory capacities 104d to 104g have the same value.

A memory area in the NAND memory area, which is in a range between zero memory capacity and the memory capacity 104d, is usable as a third memory area (a user area) for storing user data. A second logical address range is allocated to the third memory area. The host apparatus 8 sends to the SSD 10 a memory access request for the NAND memory area, by using the LBA belonging to the second logical address range. When the control unit 103 has received the memory access request from the host apparatus 8, the control unit 103 accesses the third memory area by using the physical address corresponding to the LBA included in the memory access request, which is obtained by referring to the logical/physical table 108a.

Specifically, when the control unit 103 has received the memory access request from the host apparatus 8, the control unit 103 refers to the logical/physical table 108a and acquires from the logical/physical table 108a the physical address corresponding to the LBA included in the memory access request. The control unit 103 accesses the NAND memory area by using the acquired physical address, and executes read or write of user data at the memory location in the NAND memory area, which is designated by the acquired physical address.

As has been described above, in the present embodiment, the management information including the logical/physical table 108a and the S.M.A.R.T. log data 107b are stored in different memory areas. The dedicated LBAs, which are different from the LBAs allocated to the third memory area that stores user data, are allocated to the second memory area that stores the S.M.A.R.T. log data 107b. Therefore, the control unit 103 can execute read and write of the S.M.A.R.T. log data 107b by the same procedure of the read and write of user data.

<Operation>

The operation of the information processing apparatus 1 according to the present embodiment will now be described with reference to the drawings.

FIG. 5 is a flow chart illustrating the manufacturing process of the SSD 10. A description is given of the case in which the host apparatus 8, which is connected at the time of manufacturing the SSD 10, and the power supply 7 are used.

To start with, the host apparatus 8, which is connected to the SSD 10, turns on the power supply 7, thereby supplying power to the SSD 10 (step S10).

Subsequently, the host apparatus 8 sends to the SSD 10 a diagnosis command A which instructs diagnosis of the operations of the DRAM 105, etc. Upon receiving the diagnosis command A, the control unit 103 of the SSD 10 executes a diagnosis process A for diagnosing the operations of the DRAM 105, etc. (step S20). The SSD 10 returns a diagnosis result A of the diagnosis process A to the host apparatus 8, and the host apparatus 8 saves the diagnosis result A (step S11).

Then, the host apparatus 8 sends to the SSD 10 a product information write command for writing, e.g. the management data 107a, the logical/physical table 108a, and S.M.A.R.T. log area start LBA, in a memory area corresponding to an area between the memory capacities 104a and 104e. Upon receiving the product information write command, the SSD 10 saves the product information which is given by the product information write command (step S21).

Subsequently, the host apparatus 8 sends to the SSD 10 a diagnosis command B which instructs diagnosis of the operations of the NAND memories 104A to 104H, the turn-on operation of the LED 22, etc. Upon receiving the diagnosis command B, the control unit 103 of the SSD 10 executes a diagnosis process B for diagnosing the operations of the NAND memories 104A to 104H, the turn-on operation of the LED 22, etc. (step S22). The SSD 10 returns a diagnosis result B of the diagnosis process B to the host apparatus 8, and the host apparatus 8 saves the diagnosis result B (step S12).

Then, the host apparatus 8 sends to the SSD 10 a log management data write command which instructs write of S.M.A.R.T. log data 107b in the memory area between the memory capacities 104b and 104c. Upon receiving the log management data write command, the SSD 10 saves the log management data (step S23).

Subsequently, upon receiving a Signature header from the SSD 10, the host apparatus 8 sends a reboot request to the SSD 10, and the SSD 10 is normally booted (step S24).

Thereafter, the host apparatus 8 sends to the SSD 10 a unique information write command which instructs write of the above-described unique information in the memory area between the memory capacities 104e and 104f. Upon receiving the unique information write command, the SSD 10 saves the unique information (step S25).

Next, the host apparatus 8 turns off the power supply 7, and stops power supply to the SSD 10, thus finishing the operation of the SSD 10 (step S13).

According to the above-described embodiment, since the memory capacities 104a to 104g are so set as to store information, the information can comprehensively be handled.

In addition, unlike the prior art, the S.M.A.R.T. log data 107b is not stored in the memory area between the memory capacities 104a and 104b. Instead, the S.M.A.R.T. log data 107b is stored in the memory area between the memory capacities 104b and 104c, so as to be accessible with the LBA being used as a key. Thus, the capacity of the S.M.A.R.T. log data 107b can be varied at the time of manufacture, without altering the design of the management data 107a and the logical/physical table 108a or varying the firmware.

Furthermore, since the S.M.A.R.T. log data 107b is not stored in the fixed area of the NAND memories 104A to 104H, but is stored in the memory cells that are associated with the logical/physical table 108a, the movement (refresh) of memory cells is periodically executed. Thus, even in the case of using the MLC-NAND memory, which generally has a smaller allowable number of rewrites than in the SLC-NAND memory, the allowable number of writes of a certain memory cell is not unnecessarily wasted.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
an information processing apparatus main body; and
a nonvolatile semiconductor memory drive which is accommodated in the information processing apparatus main body, the nonvolatile semiconductor memory drive including a nonvolatile semiconductor memory and a control module, the nonvolatile semiconductor memory including a first memory area which is formed of a fixed area to which a predetermined physical address range is allocated, and which stores management information including an address management table indicative of a correspondency between logical block address and physical addresses of the nonvolatile semiconductor memory, and a second memory area to which a first logical address range is allocated and which stores log data indicative of an operation condition of the nonvolatile semiconductor memory drive, and the control module accessing the first memory area by using the physical address belonging to the predetermined physical address range in a case of reading or writing the management information, and accessing the second memory area by using the physical address corresponding to the logical block address belonging to the first logical address range, which is obtained by referring to the address management table, in a case of reading or writing the log data.

2. The information processing apparatus of claim 1, wherein the nonvolatile semiconductor memory further includes a third memory area to which a second logical address range is allocated and which stores user data, and
the control module accesses, in a case where the control module receives a memory access request from the information processing apparatus main body, the third memory area by using the physical address corresponding to the logical block address included in the memory access request, which is acquired by referring to the address management table.

3. A nonvolatile semiconductor memory drive which is used as an external storage device of an information processing apparatus, comprising:
a nonvolatile semiconductor memory including a first memory area which is formed of a fixed area to which a predetermined physical address range is allocated, and which stores management information including an address management table indicative of a correspondency between logical block address and physical addresses of the nonvolatile semiconductor memory, and a second memory area to which a first logical address range is allocated and which stores log data indicative of an operation condition of the nonvolatile semiconductor memory drive; and
a control module for accessing the first memory area by using the physical address belonging to the predetermined physical address range in a case of reading or writing the management information, and accessing the second memory area by using the physical address corresponding to the logical block address belonging to the first logical address ranger which is obtained by referring to the address management table, in a case of reading or writing the log data.

4. The nonvolatile semiconductor memory drive of claim 3, wherein the nonvolatile semiconductor memory further includes a third memory area to which a second logical address range is allocated and which stores user data, and
the control module accesses, in a case where the control module receives a memory access request from the information processing apparatus, the third memory area by using the physical address corresponding to the logical block address included in the memory access request, which is acquired by referring to the address management table.
